(19) United States
(12) Patent Application Publication
(10) Pub. No.: US 2023/0076283 A1
(43) Pub. Date: Mar. 9, 2023

(54) FILM-BONDED INFUSION

(71) Applicants: Charles Tobias Mueller, Providence, RI (US); Britt C. Colombo, Bristol, RI (US)

(72) Inventors: Charles Tobias Mueller, Providence, RI (US); Britt C. Colombo, Bristol, RI (US)

(21) Appl. No.: 17/467,147

(22) Filed: Sep. 3, 2021

(51) Int. Cl. B32B 7/12; B32B 3/26; B32B 3/30; B32B 27/38; B32B 37/10

(52) U.S. Cl. CPC B32B 7/12; B32B 3/266; B32B 3/30; B32B 27/38; B32B 37/1009

(57) ABSTRACT

This disclosure includes sandwich composites comprising fiber-reinforced laminates. The disclosure further includes one or more film adhesives between a core and the fiber-reinforced laminates.

### FIELD

The present disclosure relates to composite sandwich construction. More Specifically, the present disclosure relates to systems, methods, and apparatuses for creating a composite sandwich construction in which a fiber reinforced laminate is bonded to a core (or a material other than the fiber reinforced laminate).

### BACKGROUND

Existing methods for creating composite sandwich structures include three options: (1) “wet-preg” or “wet bagging”; (2) “resin infusion”; and (3) “pre-preg.” Each of these three methods have drawbacks.

“Wet-preg” refers to wet impregnated fabric. Using the wet-preg or wet-bagging process, one mixes liquid resin and then manually forces the resin into a fabric. Suitable fabrics can include various fiberglass fabrics. Once the uncured resin and fabric matrix are together, they can then be placed onto either side of a core material. Suitable core materials include, for example, foam or wood. The structure is then allowed to cure when placed in a vacuum. One way to measure or to compare the resulting product is to determine the ratio of glass to resin, by weight (as a percentage, e.g., 60/40 could refer to 60% glass to 40% resin). Drawbacks of wet-preg include wasted resin, and increased weight due to the wasted resin and due to the process of imprecise manual wet-out of the both the laminate and core surface.

Using the “pre-preg” process, under very controlled conditions, a machine forces resin into a dry laminate at very precise resin ratios that are the lowest level possible, yet still having excellent mechanical properties. They are usable without adding any additional resin or a curing agent. More specifically, pre-pregs are re-enforced fabrics that has been pre-impregnated with a resin. Wet-preg is perceived to include too much resin. At room temperature, such resin is not a liquid but is instead semi-solid. It is pliable, but will not flow like a liquid, and full curing is prevented by keeping the pre-preg material in a frozen, dry storage area. Layers of the already impregnated composite fabric are placed on either side of the core, as well as a thin layer of pre-preg adhesive, with little to no fabric placed directly against the core, to provide enough resin to bond the fabric to the core without lowering resin content in the laminate. The entire sandwich is cured at elevated temperature under a vacuum. Drawbacks of pre-pregs include that they are far more expensive than wet-preg due to the additional labor, high temperature curing process involved, as well as much higher total material costs.

In the “resin infusion” (or “vacuum infusion”) process, vacuum pressure is used to pull a resin through a dry laminate stack, which is placed on either side of a core material, such as foam. The entire composite stack is placed under vacuum and the resin is forced through the dry laminate and the surface of the core. The process is typically performed at room temperature. The resultant product is then allowed to cure (e.g., by letting it stand at room temperature for a period of time, such as several hours or overnight). A major drawback of resin infusion is that excess resin will be absorbed into the core. This will significantly increase the weight of the end product and will result in excess resin being used (and being absorbed into the core, where it serves no useful purpose beyond adhesion to the outer-most portions of the core).

One example of the resin infusion process used with a core (sandwich structure) is the SCRIMP™ process (an acronym which stands for Seemann Composites Resin Infusion Molding Process). But the SCRIMP process has all of the disadvantages typical to existing resin infusion processes.

Advantages of sandwich composite construction include a high or very high stiffness-to-weight and high bending strength-to-weight ratio. The sandwich enhances the flexural rigidity of the structure without adding substantial weight.

New processes are desired that use less resin and produce a lighter weight component, yet still is capable of producing a strong and durable sandwich product.

### SUMMARY

The present disclosure relates to sandwich composites comprising fiber-reinforced laminates. More specifically, the present disclosure relates to sandwich composite products that include one or more film adhesives between a core and the fiber-reinforced laminates, and methods for manufacturing the same.

There are two ways to implement the disclosure: (1) infusing each laminate separately; or (2) infusing multiple laminates simultaneously.

There are several advantages to the methods and systems of this disclosure. When implemented, these advantages can include a lower weight and the use of less material than existing methods. This is because the methods and systems of this disclosure do not allow the infusion resin to penetrate and be absorbed by the core. This can save on weight as there can be less glue (e.g., infusion resin) absorbed into the core. Additionally, this can save on cost by using less liquid infusion resin.

The film-bonded infusion process of this disclosure can be used in any composite sandwich construction where a fiber-reinforced laminate needs to be bonded to a core or a material other than the fiber reinforced laminate. Applications include, without limitation, wind turbine blades, boat and automotive construction, aviation, aerospace, and structural reinforcement.

### BRIEF DESCRIPTION OF THE DRAWINGS

The foregoing and other objects, features, and advantages of the systems and methods described herein will be apparent from the following description of particular embodiments thereof, as illustrated in the accompanying figures, where like reference numbers refer to like structures. The figures are not necessarily to scale, emphasis instead being placed upon illustrating the principles of the systems and methods described herein.

FIG. 1 is a side view of a component in accordance with aspects of this disclosure.

FIG. 2 is a method for manufacturing a component in accordance with aspects of this disclosure.

FIG. 3 is a side view of a component made in accordance with aspects of this disclosure.

FIG. 4 is a method for manufacturing a component in accordance with aspects of this disclosure.

FIG. 5 is an example grid shape for breaks in a film adhesive in accordance with aspects of this disclosure.

FIG. 6 is a side view of a component made in accordance with aspects of this disclosure.

FIG. 7 is a perspective view of primary and secondary resin channels made in accordance with aspects of this disclosure.

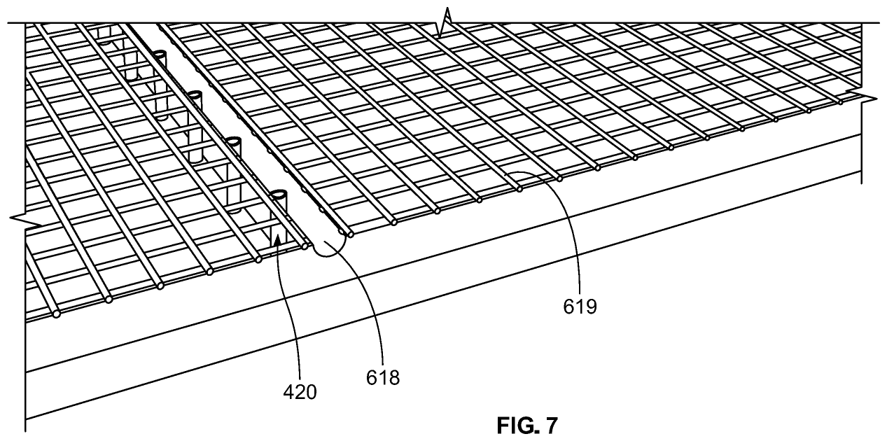

FIG. 8 is a side view of primary and secondary resin channels made in accordance with aspects of this disclosure.

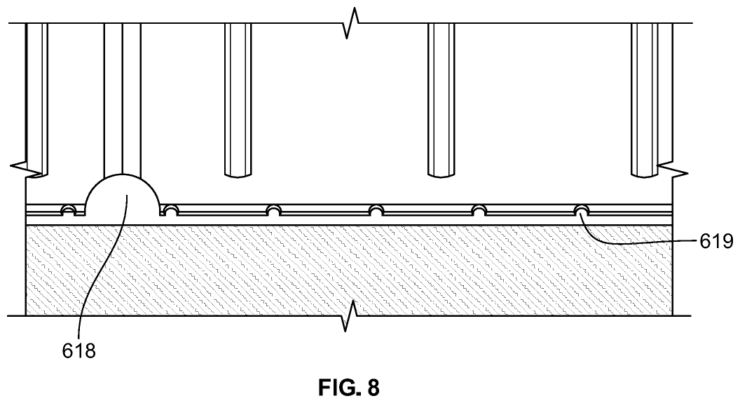

FIG. 9 is an example grid shape for breaks in a film adhesive in accordance with aspects of this disclosure.

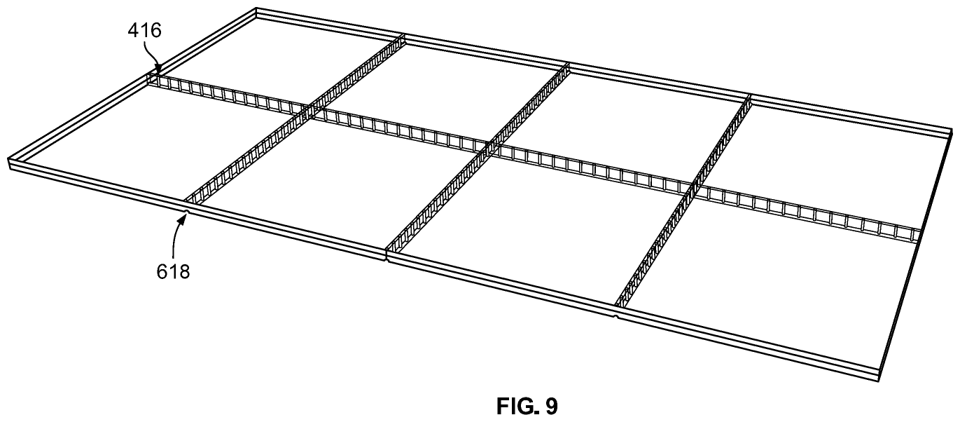

### DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms unless otherwise stated or clear from context.

As used herein, the terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples, or exemplary language (“e.g.,” “such as,” or “the like”) provided herein, is intended merely to better illuminate the embodiments and does not pose a limitation on the scope of the embodiments. The terms “e.g.,” and “for example” set off lists of one or more non-limiting examples, instances, or illustrations. No language in the specification should be construed as indicating any unclaimed element as essential to the practice of the embodiments.

As used herein, the term “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

As used herein, the terms “exemplary” and “example” mean “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention,” “embodiments,” or “invention” do not require that all embodiments of the invention include the discussed feature, advantage or mode of operation.

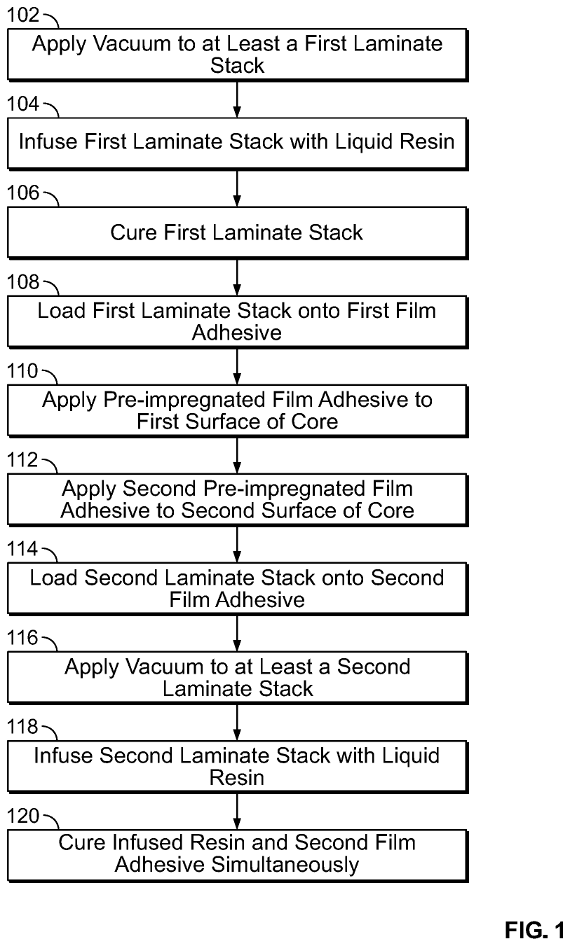

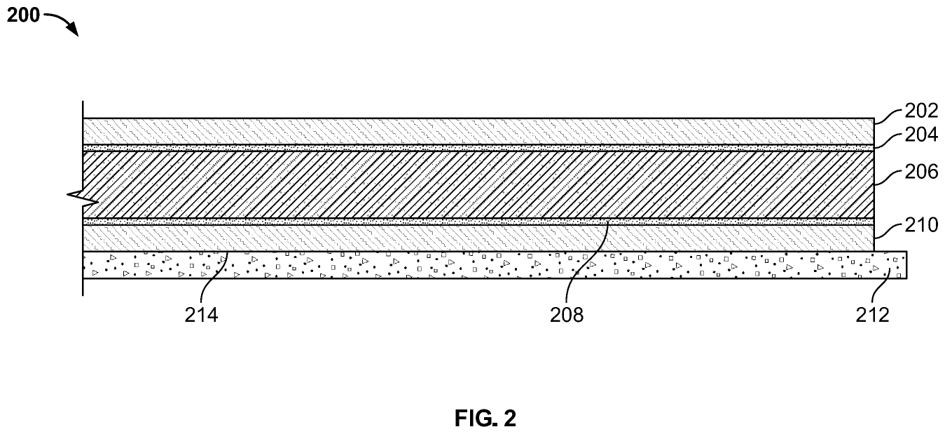

In connection with FIGS. 1 and 2, one example process of making a film-bonded infusion component includes applying a vacuum to at least the first laminate stack 102. The process may further include then infusing a first laminate stack with an infusion resin while under a vacuum 104. The process may include curing the first laminate stack 106. The process may also include loading a first laminate stack onto a first pre-impregnated film adhesive 108. The process may further include applying a first film adhesive, preferably pre-impregnated, to a first surface of a core 110.

The process may further include applying a second film adhesive, pre-impregnated, to a second surface of the core 112. The process may further include loading a second (dry) laminate stack adjacent the second film adhesive 114. A vacuum may then be applied to at least the second laminate stack 116. Initially, the laminate stack is preferably dry, not yet containing infusion resin. The process may further include infusing the second laminate with liquid resin under vacuum 118.

A curing process (e.g., like the ones described below) can then be used to cure the second infused resin in the second laminate stack 120. Preferably, this curing process will also simultaneously cure the second pre-impregnated film adhesive.

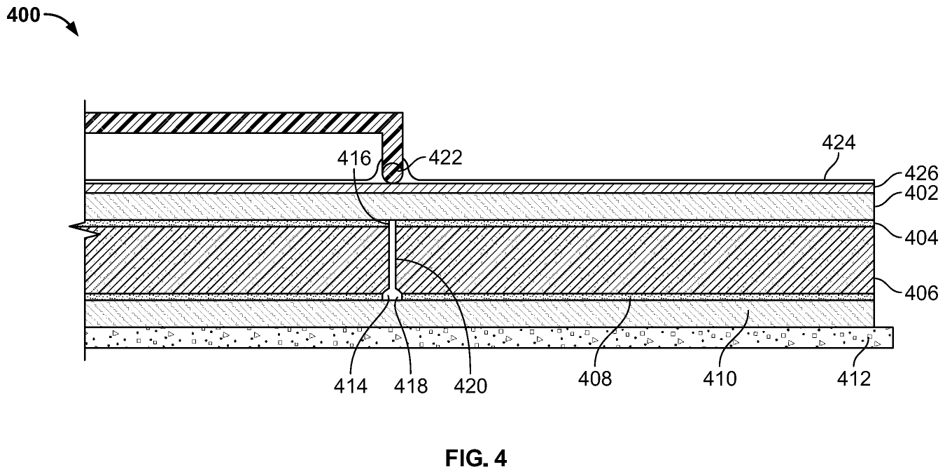

The resultant film-bonded infusion component 200 in FIG. 2 can be described as including five layers. As illustrated in FIG. 4, the product includes a first laminate 202, a first film adhesive 204, a core 206, a second film adhesive 208, and a second laminate 210. In FIG. 2, a mold structure 212 is shown, which mold structure 212 has top surface 214. The first three layers above the mold top surface 214 are the first laminate 210, a first film adhesive 208, and core a 206. The infusion resin is infused into a first laminate 210. A second film adhesive 204 and second laminate stack are then placed on the core 206. The component is again infused, with the resin this time infusing the second laminate 202 and being impeded from entering the core by the second film adhesive 204. Once the second laminate is infused, the apparatus 200 is cured, with both the second laminates 202 and the second film adhesive 204 being cured simultaneously. The component is then ready to be used or to be combined with other film-bonded infusion components into a larger structure.

One advantage of preferred embodiments is that the film adhesive 204, 208 and the infusion resin can be selected such that they are able to cure simultaneously or approximately simultaneously. This is able to occur because the preferred curing times and temperatures for the film adhesive and the infusion resin overlap. Suitable film adhesives include VF400 low temperature pre-impregnated film adhesive (also referred to as epoxy adhesive film or epoxy film), sold by SDH Composites. Suitable infusion resins include, without limitation, epoxy 2110 from Endurance Technologies, and its associated hardeners (including, without limitation, the 9227 hardener).

The film adhesive 204, 208 selected is preferably in a solid state at room temperature. When the film adhesive 204, 208 is solid at room temperature, it is impermeable to the liquid resin that is used to infuse the laminate stacks 202, 210. As a result, when the liquid resin infuses the laminate stack 210 under vacuum, the liquid resin is not able to penetrate into the core 206. This prevents or reduces unnecessary resin in the end product, and lowers the density and weight of the resultant end product as compared to products and components made using existing resin infusion processes.

Film adhesives 204, 208 that may be used in connection herewith generally include any epoxy films that are solid at room temperature and become liquid upon heating at an increased temperature, and that preferably are capable of adhering to both a wet laminate stack 210 and the material of the core 206. Examples of such film adhesives include, without limitation, VF400 low temperature pre-impregnated film adhesive (also referred to as epoxy adhesive film or epoxy film), sold by SDH Composites. Infusion resins that may be used in connection herewith generally include resins that are capable of infusing a dry laminate stack and capable of adhering to an epoxy film. Examples of such infusion resins include, without limitation, without limitation, epoxy 2110 from Endurance Technologies.

For curing, after the laminate 202, 210 stacks are infused, the structure is placed in a heated chamber or oven. The film adhesive 204, 208 becomes liquid and bonds the laminate stack(s) 202, 210 to the core. It is presently understood that primarily chemical bonds (e.g., cross-linking) secure the epoxy film to the infused, laminate stacks and that primarily mechanical bonds secure the epoxy film to the core. The simultaneous curing process creates not only primary bonds but also secondary bonds between the second laminate and the second film adhesive.

The curing preferably takes place under vacuum, at an increased temperature. Preferred temperatures can range from about 120° F. to about 180° F., and more particularly from about 140° F. to about 160° F. In example processes, the curing time can preferably range from about 10 to about 20 hours, and more particularly about 15 to about 17 hours. In one embodiment, the curing temperature is set to 150° F. and the curing time is set for about 16 hours. In a preferred embodiment, the ramp up time from approximately room temperature to 150° F. may be, for example, between about 1 and about 3 hours, and is preferably about 2 hours.

The heating process preferably takes place after the infusion process is completed, but before the infusion resin is cured or before the infusion resin is fully cured.

The core may be generally flat or can be any three-dimensional shape desired.

Suitable materials for the core include, without limitation, foam (including without limitation polyurethane foam or Styrofoam), balsa wood, plywood, and plastics. In preferred embodiments, the core may be approximately 1 mm to 100 mm thick and may have non-uniform, varied thicknesses. Other thicknesses may be used as well, as one skilled in the art can appreciate in light of this disclosure.

Materials used in the laminate stacks include, without limitation, fibers made from carbon, Kevlar®, aramid, fiberglass, and/or basalt.

The methods and systems described herein could be generally described as a hybrid method of composite sandwich core construction. One preferred method combines the best attributes of the pre-preg process (e.g., lightweight and little or no wasted infusion resin) and the infusion process (minimal excess air or air bubbles) to achieve a pre-preg quality product (or better) at closer to resin infusion level production costs (or lower). Excess air within the infused laminate stack is known to weaken the components containing that air, which weaknesses may cause failure.

The processes described herein are believed to be usable with small scale and large scale parts.

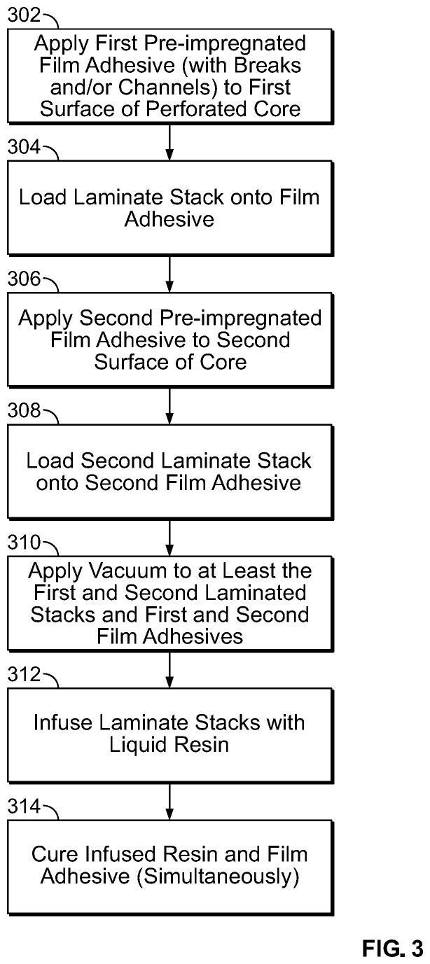

In an alternative embodiment (illustrated in FIGS. 3 and 4), the infusion is preferably performed in one infusion step instead of two infusion steps. As illustrated in FIG. 4, this is accomplished the through the inclusion of feed grooves 414 and perforations 420 in the core and breaks 416, 418 in the layers of film adhesive. During a single step of infusion, the infusion resin is able to infuse a second laminate stack 402 during a vacuum pull by contacting the second laminate stack 402. The pre-impregnated film adhesive selected 402, 410 is preferably in a solid state at room temperature. When the film adhesive is solid at room temperature, it is impermeable to the liquid resin that is used to infuse the laminate stack. The infusion resin is also able to infuse a first laminate stack because breaks 416, 418 are provided in the film adhesive 404, 408. The breaks 416, 418 are preferably spatially lined up with the feed grooves 414 and perforations 420 in the core 406.

Thus, under vacuum and at room temperature, even though the film adhesive 404, 408 is impermeable to the infusion resin, the breaks 416, 418 in the film adhesive, which are lined up with the grooves 414 and perforations 420 in the core 406, permit the infusion to have paths to the second laminate stack 410. Compared to existing resin infusion processes, this results in much less infusion resin being absorbed into the core 406. This is able to occur, in part, because the infusion resin is absorbed into the core 406 in only the vicinity of the grooves and/or perforations in the core. In contrast, using an existing resin infusion process, the liquid resin could be absorbed into the core 406 across the entire area of the core. In turn, the component may be lighter than if an existing resin infusion process were used.

A layer of compoflex 426 adjacent the first laminate stack 404 may also be used during the infusion process. The compoflex 426 facilitates the distribution of the infusion resin across the laminate stack 404. The compoflex 426 is preferably removed upon completion of the infusion process and prior to part service. Compoflex may be used in connection with either the one step or two step infusion process.

The resultant film-bonded infusion component 400 in FIG. 4 can be described as including five layers. As illustrated in FIG. 2, during manufacture, a compoflex infusion medium 401 is preferably used. The product includes a first laminate 202, a first film adhesive 204, a core 206, a second film adhesive 208, and a second laminate 210. In FIG. 4, a mold structure 212 is shown. A vacuum bag 426 is also illustrated, as is a feed line 422 for the introduction of an infusion resin. In a preferred embodiment, the infusion resin is infused into both first and second laminates 210, 202, then cured. The component is then ready to be used or to be combined with other film-bonded infusion components into a larger structure.

In an alternative embodiment, the infusion is preferably performed in one infusion step instead of two. The film adhesive may have perforations 420 and/or grooves 414, while the film adhesives 404, 408 has breaks 416, 418 that preferably align with the grooves 414 and/or perforations 420.

In connection with FIG. 3, one example process includes applying a first pre-impregnated film adhesive to a first surface of a perforated core 302. The process may further include loading the first laminate stack onto the film adhesive 304. Initially, the laminate stack is preferably dry, not yet containing infusion resin. The process can further include applying a second pre-impregnated film adhesive to a second surface of the core 306. The process and further include loading a second (dry) laminate stack adjacent the second film adhesive 308. A vacuum may then be applied to at least the first and second laminated stacks and the first and second film adhesives 310. The process may further include then infusing a first and second laminate stacks with an infusion resin while still under a vacuum 312. The first and second laminated stacks and the first and second film adhesives same materials may then be cured 314.

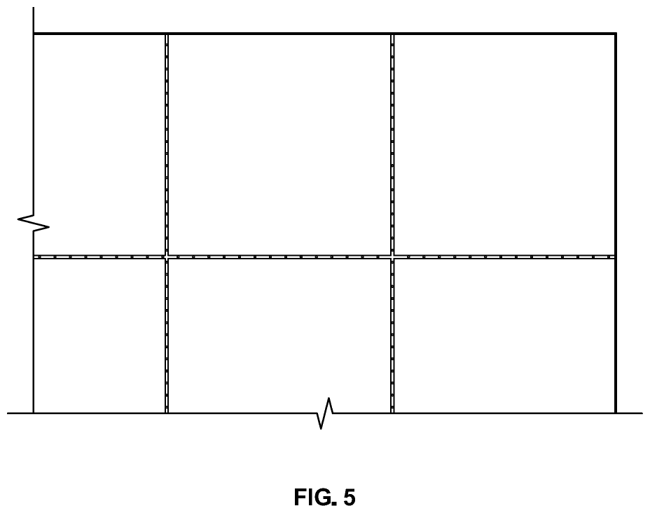

In FIG. 5, an example pattern or grid illustrating feed lines 422 that correspond to breaks 416, 418 in the film adhesive. The breaks 416, 418 are preferably aligned with the grooves and/or perforations in the core and the feed lines 422 are preferably aligned with the grooves and perforations. The shapes and orientation of the breaks 416, 418 (and feed lines 422) may be designed or modified based, for example, on the core thickness, the laminate thickness, and the geometry of the component being formed.

The two step infusion process may be preferred in applications for mass production of components. One drawback of the two step infusion process is that one of the surfaces is typically rougher than the other. That is because one side has mold quality (adjacent laminate 210) and the other side typically does not (and is thus rougher than the mold quality surface.

The one step infusion process may produce two mold quality surfaces and will be more precise. It may therefore be preferred for specialized or unique production of components that require more precision on both outer surfaces.

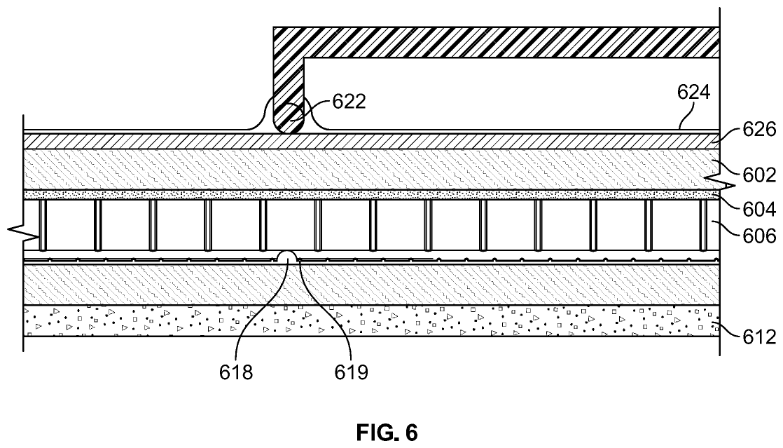

In an alternative embodiment illustrated in FIG. 6, an additional variation of the one-shot process is included. In the process, the bottom surface of the core is has additional, secondary resin channels 619 added, which connect to one or more main resin channels 618 and may be smaller in size than the main resin channels 618. These secondary resin channels 619 differ from the main channels 618 in that they are preferably smaller or much smaller in size than the main channels (which may be measured by a radius, a curvature or otherwise), and are covered with the film adhesive. The main channels 618 preferably coincide with the breaks 416, 418.

The film adhesive is vacuum bagged to the surface of the core to ensure the film adhesive properly follows the contour of the additional resin feed channels. The secondary resin channels 619 preferably are in fluid communication with the main channels 618 to make transfer of resin into the laminate easier. Preferably, when the film adhesive is pulled into the secondary feed channels 619, the resin flows from the main channels 618, below the film adhesive (through breaks), then uses the space beneath the secondary channels (and, at this point also below the film adhesive, which has been pulled into the secondary channels. As with earlier embodiments described, the depth and grid pattern of these smaller channels again may vary based upon reinforcement type and thickness.

While particular embodiments have been shown and described, it will be apparent to those skilled in the art that various changes and modifications in form and details may be made therein without departing from the spirit and scope of this disclosure and are intended to form a part of the inventions as defined by the following claims, which are to be interpreted in the broadest sense allowable by law. Further, the sequence of steps for the example methods described or illustrated herein are not to be construed as necessarily requiring their performance in the particular order described or illustrated unless specifically identified as requiring so or clearly identified through context. Moreover, the example methods may omit one or more steps described or illustrated, or may include additional steps in addition to those described or illustrated. Thus, one of ordinary skill in the art, using the disclosures provided herein, will appreciate that various steps of the example methods can be omitted, rearranged, combined, and/or adapted in various ways without departing from the spirit and scope of the inventions.

1-11. (canceled)
